(19) United States
(12) Patent Application Publication
(10) Pub. No.: US 2009/0088140 A1
(43) Pub. Date: Apr. 2, 2009

(54) Method and apparatus for enhanced telecommunication interface

(76) Inventors: Rami Caspi, Sunnyvale, CA (US); William J. Beyda, Cupertino, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/904,653

(22) Filed: Sep. 27, 2007

(51) Int. Cl. H04M 3/42; G10L 13/00

(52) U.S. Cl. 455/415; 704/260; 704/E13.001

(57) ABSTRACT

A telecommunications system including a telephone including a calling party identification receiver and a peripheral device transceiver; and a headset configured to communication with the telephone via the peripheral device transceiver and configured to deliver calling party identification information to a user as audio information.

### BACKGROUND OF THE INVENTION

1. Field of the Invention

This invention relates to telecommunications devices. More particularly, the invention relates to an improved telephony interface for communication devices.

2. Description of the Related Art

Modern cellular telephones are often accessorized with wireless earpieces equipped with a speaker and microphone. Generally, the user attaches the cellular telephone to a belt holster or places the cellular telephone in a purse while wearing the earpiece in his or her ear. The user can answer a telephone call by pressing a button on the earpiece. Typically, the earpieces communicate with the cellular telephone using the Bluetooth or other ad hoc networking over the unlicensed Industrial, Scientific, and Medical (ISM) spectrum of 2.4 GHz.

While cellular telephones are often equipped with caller identification (“Caller ID”), in which a calling party number and/or name is displayed on an LCD or other display, taking advantage of the service requires that the cellular telephone be removed from the purse or holster. While some earpiece manufacturers provide a small display on the earpiece, using it requires that the user remove the earpiece from his ear. Both obviate the advantages of having an earpiece. Thus, a user of a cellular telephone equipped with a wireless earpiece must either answer all incoming calls or sacrifice the advantages of having an earpiece at all.

As such, there is a need for a method for providing caller ID data to a cellular telephone user employing a wireless earpiece. There is a further need for an improved method for call screening in a cellular telephone equipped or accessorized with an earpiece.

### SUMMARY OF THE INVENTION

These and other drawbacks in the prior art are overcome in large part by a system and method according to embodiments of the present invention.

A telecommunications system according to embodiments of the present invention includes a cellular telephone and a Bluetooth-compatible headset, said cellular telephone including a calling party identification unit configured to determine a calling party number, wherein the cellular telephone is configured to provide calling party identification information to the Bluetooth-compatible headset for audio delivery. According to some embodiments, the cellular telephone is configured to convert text-based calling party identification information to speech prior to delivery to the headset. In others, the cellular telephone is configured to provide text-based calling party identification information to the headset and the headset is configured to convert the text to speech prior to delivery to the headset.

A telecommunications method in accordance with embodiments of the present invention includes receiving text-based calling party identification information at a telephone; converting the text-based calling party identification information to speech; and delivering calling party identification information as speech to a remote headset associated with the telephone. In some embodiments, the converting includes transmitting the text-based calling party identification information to the headset and performing a text-to-speech conversion at the headset. In others, the converting includes converting the text-based calling party identification to speech at the telephone and transmitting the speech-converted calling party identification information to the headset.

A telecommunications system in accordance with embodiments of the present invention includes a telephone including a calling party identification receiver and a peripheral device transceiver; and a headset configured to communication with the telephone via the peripheral device transceiver and configured to deliver calling party identification information to a user as audio information.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary system according to embodiments of the present invention.

FIG. 2A and FIG. 2B are block diagrams of systems according to embodiments of the present invention.

FIG. 3 is a flowchart illustrating operation of an embodiment of the present invention.

FIG. 4 is a flowchart illustrating operation of an embodiment of the present invention.

FIG. 5A-FIG. 5C illustrate exemplary operation of embodiments of the present invention.

FIG. 6 is a flowchart illustrating operation of an embodiment of the present invention.

FIG. 7 is a flowchart illustrating operation of an embodiment of the present invention.

FIG. 8 illustrates exemplary signaling for an embodiment of the present invention.

### DETAILED DESCRIPTION OF EMBODIMENTS OF THE INVENTION

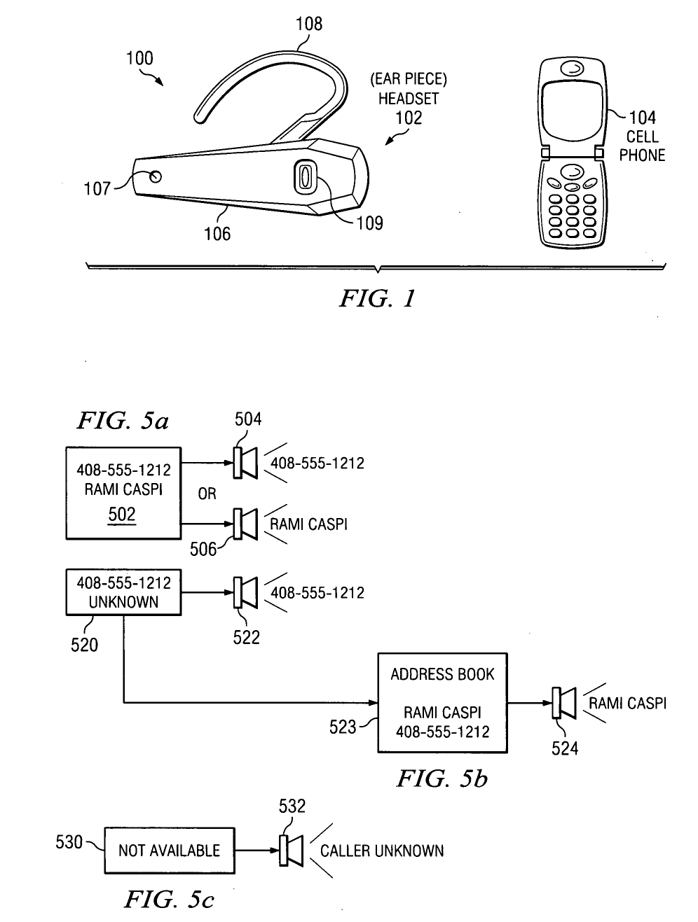

Turning now to the drawings and, with particular attention to FIG. 1, a diagram of a telecommunications system 100 according to an embodiment of the present invention is shown.

The telecommunications system 100 includes a headset 102 and a base unit 104 that may be implemented as, for example, a cellular telephone. As will be explained in greater detail below, the base unit 104 and the headset 102 may be in wireless communication with one another. For example, low power wireless transceivers within the base unit 104 and the headset 102 may allow wireless radio communication between the units. The transceivers may be implemented using any suitable transceivers, such as those using radio frequency (RF), infrared, or light emissions. In a particular implementation, the transceivers may be embodied as Bluetooth compatible transceivers.

It is noted that, although described herein as a wireless headset, the headset 104 could be implemented as a wired telephone headset or other hands-free communication device, without departing from the scope if the present invention.

In the embodiment illustrated, the headset 102 includes an ear mount 108 and a control unit housing 106. The control unit housing 106 houses, e.g., a microphone and speaker, transceiver, and various user controls, as will be explained in greater detail below. The ear mount 108 typically supports the headset 102 on the ear or the user. The ear mount 108 includes a hook that has a shape that complements the external contour of the user's ear. In some embodiments, the hook portion may be elastically deformed so as to be easily wrapped around the user's ear.

The control unit housing 106 may various user controls 107, 109, such as an on/off switch and a call answer switch, respectively, as will be explained in greater detail below. In operation, the headset 102 receives audible calling party identification information from the cellular telephone 104. The user can then accept the call, typically by depressing the call answer button 109, although in some embodiments, voice control techniques may be used.

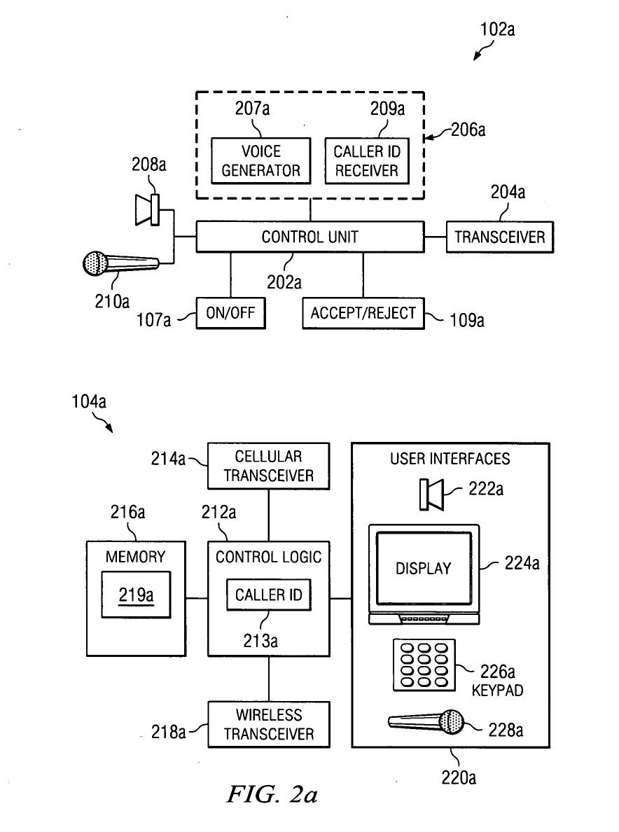

A block diagram of an exemplary system in accordance with embodiments of the present invention is shown in FIG. 2A. In particular, FIG. 2A illustrates a system in which the headset 102a receives caller identification information and performs a text-to-speech conversion on it and then delivers an audible caller identification information to the user via the speaker.

The system includes headset 102a and a telephone 104a. In some embodiments, the cellular telephone 104a may implement one or more elements of the methods disclosed herein. As shown, the cellular telephone 104a includes control logic 212a and cellular transceiver 214a. The cellular transceiver 214a allows communication over a cellular telephone network, such as a GSM or GPRS based cellular telephone network. The control logic 212a generally controls operation of the cellular telephone and, in some embodiments, implements caller identification unit 213a in accordance with embodiments of the present invention. In addition, the control logic 212a may interface to a peripheral device transceiver 218a, which may implement, for example, a low power, short range RF transceiver, such as a Bluetooth compatible transceiver.

The control logic 212a interfaces to a memory 216a for storing, among other things, contact or address lists. The control logic 212a also interfaces to a user interface(s) 220a. The user interface(s) 220a can include a keypad 226a , speaker 222a, microphone 228a, and display 224a. The keypad 226a may include one or more “hard” keys and may be implemented in whole or in part as a cursor pointing device in association with one or more “virtual” keys on the display 224a. In general, a user may make use of the keypad 226a and display 224a to enter contact information, and may speak into the microphone 228a to provide the audio input(s). It is noted that other interfaces, such as voice activated interfaces may be provided. Thus, the figure is exemplary only.

The headset 102a includes control logic 202a that generally controls operation of the headset. The control logic 202a controls operation of a transceiver 204a for communicating with the cellular telephone 104a. As noted above, the transceiver 204a may implement a low power, short range transceiver, such as a Bluetooth transceiver for communicating with transceiver 218a on the cellular telephone 104a. In addition, the control logic 202a includes or is in communication with user interfaces, such as a speaker 208a, microphone 210a, and one or more control buttons or switches 107a, 109a, such as an ON/OFF switch 107a and an accept/reject call switch 109a.

In addition, in accordance with embodiments of the present invention, the control unit 202a includes or is in communication with a caller ID control unit 206a. The caller ID control unit 206a includes a caller ID receiver/decoder 209a and a voice generator or text-to-speech unit 207a.

In operation, the cellular telephone 104a receives caller identification information at the caller identification unit 213a, for example, while the telephone is ringing to indicate an incoming call. The cellular telephone 104a then relays the information to the headset 102a's caller id receiver 209a. The caller id receiver 209a provides the information to the text-to-speech unit 207a, which converts the incoming caller id information to an audible format, which is then spoken or played out to the user via the speaker 208a. Any suitable text-to-speech engine may be employed.

In some embodiments, the text-to-speech unit 207a converts caller identification information such as the name of the caller or the number of the caller. In some embodiments, however, the text-to-speech unit 207a may access an address book 219a of the cellular telephone 104a for a calling party identity. That is, in some embodiments, the headset 102a can request a lookup to determine if the number corresponds to a stored number. If so, then the name of the party corresponding to the number is relayed and converted. It is noted that, in some embodiments, the address book 219a could be stored at the headset 102a; thus no further communication would be required.

To accept the call, the user can activate the accept/reject button 109a. The headset 102a then communicates a request to the cellular telephone 104ato complete the call.

A block diagram of an exemplary system in accordance with embodiments of the present invention is shown in FIG. 2B. In particular, FIG. 2B illustrates a system in which a cellular telephone receives caller identification information and performs a text-to-speech conversion on it prior to transferring the information as voice to the headset. The headset then delivers the information to the user via the headset speaker.

The system includes headset 102b and a telephone 104b. In some embodiments, the cellular telephone 104b may implement one or more elements of the methods disclosed herein. As shown, the cellular telephone 104b includes control logic 212b and cellular transceiver 214b. The cellular transceiver 214b allows communication over a cellular telephone network, such as a GSM or GPRS based cellular telephone network. The control logic 212b generally controls operation of the cellular telephone and, in some embodiments, implements caller identification unit 213b and text-to-speech unit 207b in accordance with embodiments of the present invention. In addition, the control logic may interface to a peripheral device transceiver 218b, which may implement, for example, a low power, short range RF transceiver, such as a Bluetooth compatible transceiver.

The control logic 212b interfaces to a memory 216b for storing, among other things, contact or address lists 219b. The control logic 212b also interfaces to a user interface(s) 220b. The user interface(s) 220b can include a keypad 226b, speaker 222b, microphone 228b, and display 224b. The keypad 226b may include one or more “hard” keys and may be implemented in whole or in part as a cursor pointing device in association with one or more “virtual” keys on the display 224b. In general, a user may make use of the keypad 226b and display 224b to enter contact information, and may speak into the microphone to provide the audio input(s). It is noted that other interfaces, such as voice activated interfaces may be provided. Thus, the figure is exemplary only.

The headset 102b includes control logic 202b and generally controls operation of the headset. The control logic 202b controls operation of a transceiver 204b for communicating with the cellular telephone 104b. As noted above, the transceiver 204b may implement a low power, short range transceiver, such as a Bluetooth transceiver for communicating with transceiver 218b on the cellular telephone 102b. In addition, the control logic 202b includes user interfaces, such as a speaker 208b, microphone 210b, and one or more control buttons or switches 107b, 109b, such as an ON/OFF switch 107b and an accept/reject call switch 109b.

In operation, the cellular telephone 104b receives caller identification information at the caller identification unit 213b, for example, while the telephone is ringing to indicate an incoming call. The cellular telephone 104b's voice generator or text-to-speech unit 207b then converts the incoming caller ID information from text into an audio format. Any suitable text-to-speech engine may be employed. The control logic 212b then relays the audible caller ID information to the headset 102b via the respective transceivers. The headset 102b then plays the information to the user via the headset speaker 208b.

In some embodiments, the text-to-speech unit 207b converts caller identification information such as the name of the caller or the number of the caller as provided. In some embodiments, however, the text-to-speech unit 207b may access an address book 219b of the cellular telephone 104b for a calling party identity. That is, in some embodiments, the control logic 212b can request or perform a lookup to determine if the number corresponds to a stored number. If so, then the name of the party corresponding to the number is converted and relayed to the headset 102b.

To accept the call, the user can activate the accept/reject button 10b9. The headset 102b then communicates a request to the cellular telephone 104b to complete the call.

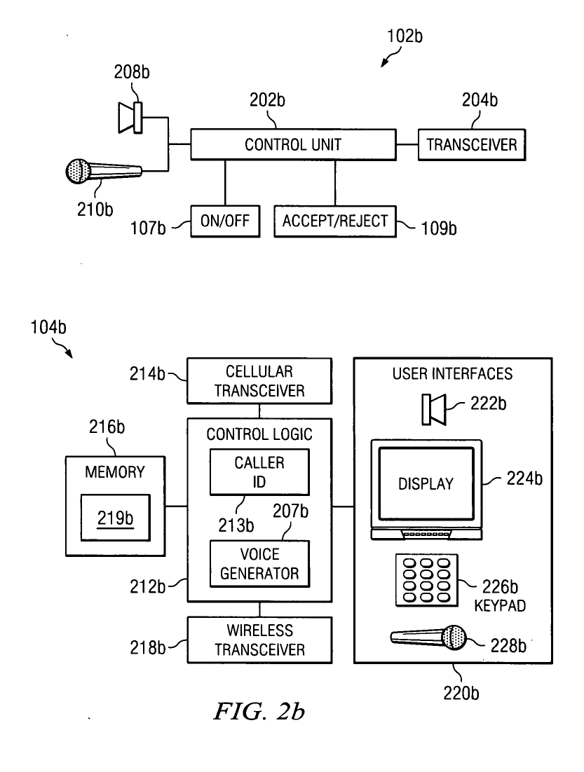

FIG. 3 illustrates a flowchart 300 of an embodiment of the present invention. The particular arrangement of elements in the flowchart 700 is not meant to imply a fixed order to the elements; embodiments can be practiced in any order that is practicable.

In a process step 302, a telephone call may arrive at the cellular telephone 104a. In response, the cellular telephone 104a rings and receives or otherwise generates caller ID data, in a process step 304. In a process step 306, the cellular telephone 104a contacts the headset 102a via transceivers 204a, a 218a. In some embodiments, this can include waking the headset 102a from a sleep state or initiating an initial connection.

In a process step 308, the headset 102a rings as the cellular telephone 104a sends the ring signal. In a process step 310, the cellular telephone caller ID unit 213a sends its data to the headset 102a, via the transceivers 204a, 218a where it is received at the caller ID receiver 209a. In a process step 312, the text-to-speech generator 207a receives the caller ID data and performs a text-to-speech conversion on it. In a process step 314, the headset 102a speaks the data to the user via the speaker 208a.

In a process step 316, the user can accept or reject the call, for example, by activating control 109a. If the user accepts the call, then in a process step 318, the headset 102a transmits the acceptance to the cellular-telephone 104a via the transceivers 204a, 218a. In a process step 318, the cellular telephone 104a answers the call and connects the call to the headset 102a.

If the user does not accept the call, then in a process step 322, the headset 102a transmits the rejection to the cellular telephone 104a. Finally, in a process step 324, the cellular telephone 104a refuses the connection or hangs up.

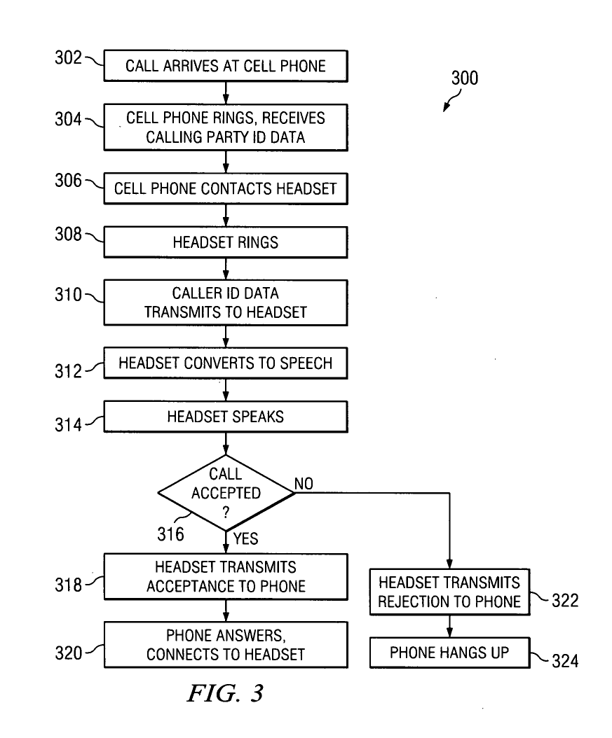

FIG. 4 illustrates a flowchart 400 of an embodiment of the present invention. The particular arrangement of elements in the flowchart 400 is not meant to imply a fixed order to the elements; embodiments can be practiced in any order that is practicable.

In a process step 402, a telephone call may arrive at the cellular telephone 104b. In response, the cellular telephone 104b rings and receives or otherwise generates caller ID data, in a process step 404. In a process step 406, the cellular telephone's text-to-speech generator 207b converts the caller ID data to voice caller ID data.

In a process step 408, the cellular telephone 104b contacts the headset 102b via the transceivers 204b, 218b. In some embodiments, this can include waking the headset 102b from a sleep state or initiating an initial connection. In a process step 410, the headset 102b rings.

In a process step 412, the cellular telephone voice unit 213 sends its voice caller ID data to the headset 102b via the transceivers 204b, 218b. In a process step 414, the headset 102b speaks the data to the user via the speaker 104b.

In a process step 416, the user can accept or reject the call, for example, by activating control 109a. If the user accepts the call, then in a process step 418, the headset 102b transmits the acceptance to the cellular telephone 104b via the transceivers 204b, 218b. In a process step 420, the cellular telephone 104b answers the call and connects the call to the headset 102b.

If the user does not accept the call, then in a process step 422, the headset 102b transmits the rejection to the cellular telephone 104b. Finally, in a process step 424, the cellular telephone 104b refuses the connection or hangs up.

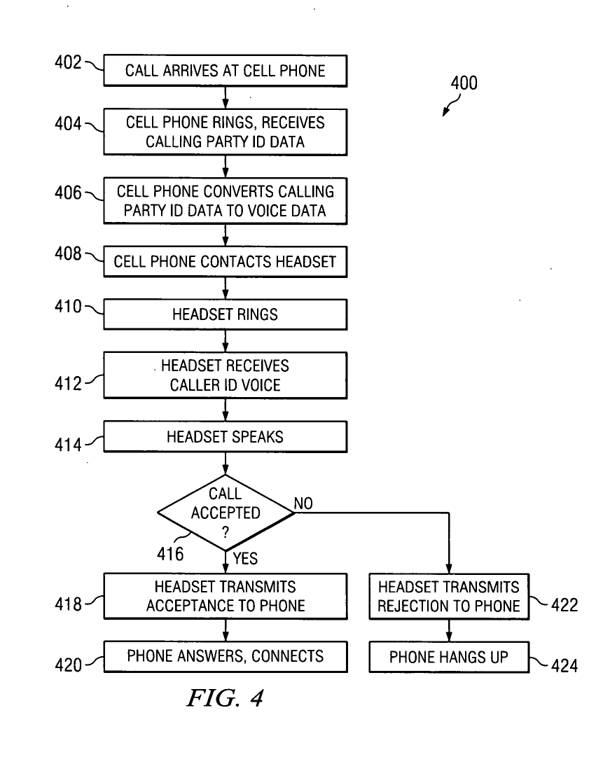

As noted above, in some embodiments of the present invention, the headset speaks or plays the incoming caller ID information, such as the provided number or name. This is illustrated in FIG. 5A. In particular, shown in FIG. 5A is an exemplary caller ID screen 502, showing phone number 408-555-1212 and associated name, RAMI CASPI. As shown at 504, the telephone number may be spoken; at 506, the name may be spoken.

However, the name associated with a number is often not known. In such cases, the system in accordance with embodiments of the present invention will use the number to perform a lookup of a local address book. If the caller is known to the user, there typically will be such an entry. In this case, if there is an entry, the caller's name will be spoken. Otherwise, the only the number will be spoken. This is illustrated in FIG. 5B. As shown, caller ID screen 520 provides a telephone number but the party name is Unknown. In this case, as discussed above, the system can access an address book such as address book 523. If there is a match, then name will be accessed and played out, as shown at 524. If not, then just the number will be played, at 522.

Finally, in some cases, neither the number nor the name are available or known, as shown at 530 in FIG. 5C. In such as case, shown at 530, the system in accordance with embodiments of the present invention will simply recite that the caller is unknown or caller ID information is not available as shown at 532.

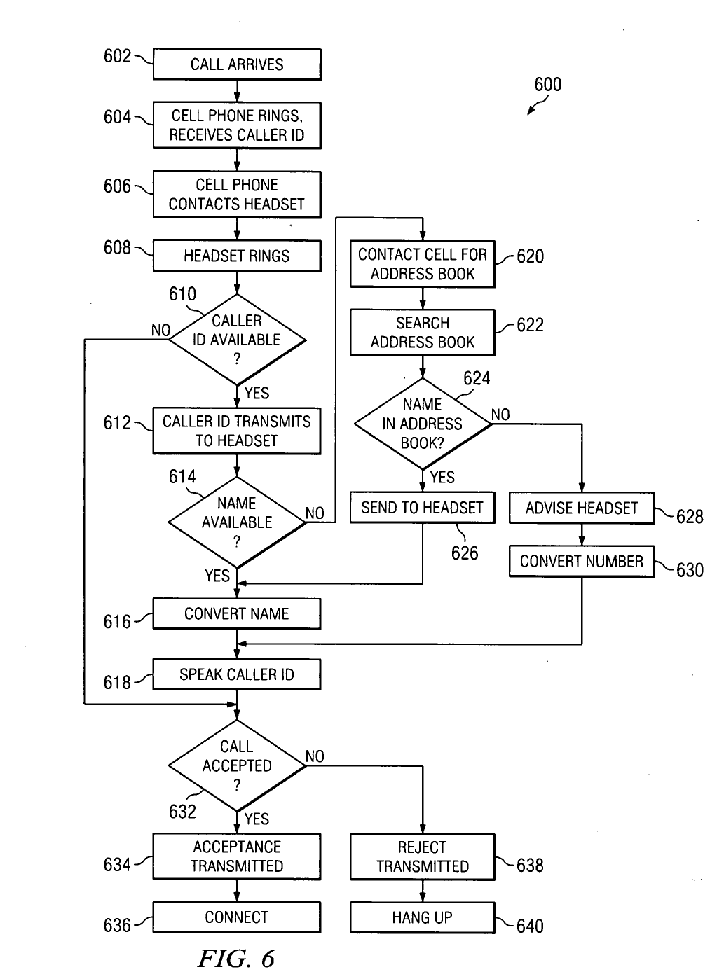

FIG. 6 illustrates a flowchart 600 of an embodiment of the present invention. The particular arrangement of elements in the flowchart 600 is not meant to imply a fixed order to the elements; embodiments can be practiced in any order that is practicable.

In a process step 602, a telephone call may arrive at the cellular telephone 104a. In response, the cellular telephone 104a rings and receives or otherwise generates caller ID data, in a process step 604. In a process step 606, the cellular telephone 104a contacts the headset 102a via the transceivers. In some embodiments, this can include waking the headset 102a from a sleep state or initiating an initial connection.

In a process step 608, the headset 102a rings as the cellular telephone 104a sends the ring signal. In a process step 610, if caller ID data is available, then in a process step 612, the cellular telephone caller ID unit 216a sends its data to the headset 102a via the transceivers 204a, 218a, where it is received at the caller ID receiver 209a. Otherwise, in a process step 614, if the calling party name is available, then in a step 618, the text-to-speech generator 207a receives the caller ID data and performs a text-to-speech conversion on it. In a process step 616, the headset 102a speaks the data to the user via the speaker 208a.

In a process step 632, the user can accept or reject the call, for example, by activating control 109a (whether or not caller ID is available). If the user accepts the call, then in a process step 634, the headset 102a transmits the acceptance to the cellular telephone 104a. In a process step 636, the cellular telephone 104a answers the call and connects the call to the headset 102a.

If the user does not accept the call, then in a process step 638, the headset 102a transmits the rejection to the cellular telephone 104a via the transceivers 204a, 218a. Finally, in a process step 640, the cellular telephone 104a refuses the connection or hangs up.

Back in process step 614, if a name was not available, then in a process step 620, the headset 102a contacts the cell phone 104a for the address book 219a via the transceivers 204a, 218a. In a process step 622, the address book 219a is searched for a name corresponding to the provided number. In a process step 624, if it is determined that the name is in the address book 219a, in a process step 626, it is sent to the headset 102a, and the name is converted, and resumes at process step 616. If there is no corresponding name, then the headset 102a is advised, in a process step 628 and the number alone is converted, in a step 630 and resumes at process step 618.

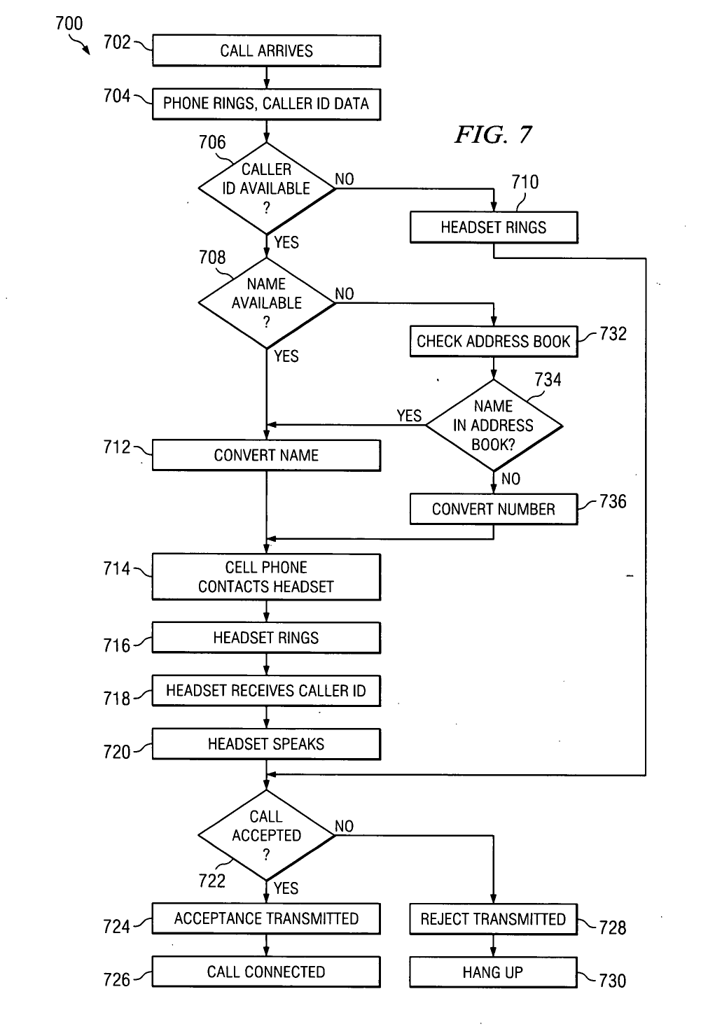

FIG. 7 illustrates a flowchart 700 of an embodiment of the present invention. The particular arrangement of elements in the flowchart 700 is not meant to imply a fixed order to the elements; embodiments can be practiced in any order that is practicable.

In a process step 702, a telephone call may arrive at the cellular telephone 107b. In response, the cellular telephone 107b rings and receives or otherwise generates caller ID data, in a process step 704.

In a process step 706, if caller ID data is available, then in a process step 708, the cellular telephone 104b determines if a name is available. If so, then the text-to-speech generator 207b converts the caller ID data to voice caller ID data in a process step 712. If a name is not available, then in a process step 732, the address book 219b is checked. If a name is in the address book 219b, as determined in process step 734, or the name had been available (process step 708), then the name is converted in a process step 712. Otherwise, the number is converted, in a process step 736. If, in process step 706, no caller ID information had been available, then the caller can accept or reject the call, at process step 722.

In a process step 714, the cellular telephone 107b contacts the headset 102b via the transceivers. In some embodiments, this can include waking the headset 102b from a sleep state or initiating an initial connection. In a process step 716, the headset 102b rings as the cellular telephone 107b.

In a process step 718, the cellular telephone voice unit 213b sends its voice caller ID data to the headset 102b. In a process step 720, the headset 102b speaks the data to the user via the speaker 208b.

In a process step 722, the user can accept or reject the call, for example, by activating control 109b. If the user accepts the call, then in a process step 724, the headset 102b transmits the acceptance to the cellular telephone 102b. In a process step 726, the cellular telephone 104b answers the call and connects the call to the headset 102b.

If the user does not accept the call, then in a process step 728, the headset 102b transmits the rejection to the cellular telephone 104b. Finally, in a process step 730, the cellular telephone 104b refuses the connection or hangs up.

As discussed above, according to some implementations of the present invention, a Bluetooth compatible transceiver is used for the headset-cell phone communication. In particular, a modified Bluetooth Headset Profile may be provided in accordance with embodiments of the present invention.

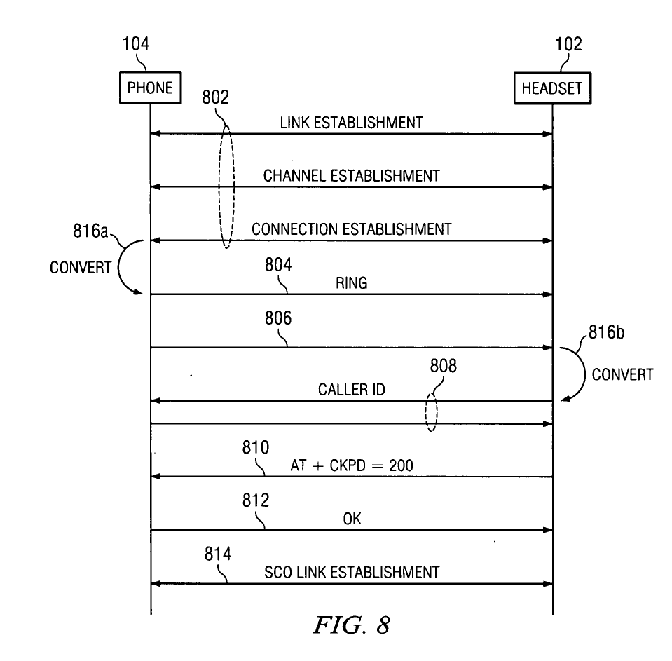

Turning now to FIG. 8, a diagram schematically illustrating signaling for such a modified Bluetooth Headset Profile is shown. Shown are a cell phone and a headset. The headset and cell phone may communicate for Bluetooth Link, Channel, and Connection establishment at 802. At 804, the phone 104 sends a RING to the headset. At 806, the phone 104 sends caller ID data.

As discussed above, this may simply include forwarding caller ID data, received from a switch (not shown), or may include voice converted data, converted at 816a . If necessary, at 816b, the headset can do any necessary conversions on the data, as discussed above, and can, if necessary, access the address book 219 of the cell phone, as discussed above, at 808. Once data has been received, the call can be accepted at 810 via the appropriate AT command. At 812, the phone 104 sends an acknowledgement, and at 814, an SCO link is established between the phone and the headset.

While specific implementations and hardware/software configurations for the mobile computing device have been illustrated, it should be noted that other implementations and hardware configurations are possible and that no specific implementation or hardware/software configuration is needed. Thus, not all of the components illustrated may be needed for the computing device implementing the methods disclosed herein.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described embodiments are intended to illustrate the principles of the invention, but not to limit the scope of the invention. Various other embodiments and modifications to these preferred embodiments may be made by those skilled in the art without departing from the scope of the present invention.

What is claimed is:

1. A telecommunications system, comprising:
a telephone including a calling party identification receiver and a peripheral device transceiver;
a headset configured to communication with the telephone via the peripheral device transceiver and configured to deliver calling party identification information to a user as audio information.

2. A telecommunications system in accordance with claim 1, said peripheral device transceiver comprising a Bluetooth-compatible transceiver.

3. A telecommunications system in accordance with claim 1, said telephone further including a text-to-speech engine configured to convert calling party identification information from text to speech and transmit speech calling party identification information to the headset.

4. A telecommunications system in accordance with claim 1, said telephone further configured to transmit text calling party identification information to the headset.

5. A telecommunications system in accordance with claim 4, said headset further including a text-to-speech engine configured to convert text calling party identification information from text to speech.

6. A telecommunications system in accordance with claim 1, further including an address book at said telephone, said telephone configured to identify a name corresponding to a received calling party identification telephone number and provide said name as said calling party identification information.

7. A telecommunications system in accordance with claim 1, further including an address book at said telephone, said headset configured to identify a name corresponding to a received calling party identification telephone number and receive said name as said calling party identification information.

8. A telecommunications system in accordance with claim 1, said telephone comprising a cellular telephone.

9. A telecommunications method, comprising:
receiving text-based calling party identification information at a telephone;
converting said text-based calling party identification information to speech; and
delivering calling party identification information as speech to a remote headset associated with the telephone.

10. A telecommunications method in accordance with claim 9, said converting including transmitting the text-based calling party identification information to the headset and performing a text-to-speech conversion at said headset.

11. A telecommunications method in accordance with claim 9, said converting including converting the text-based calling party identification to speech at the telephone and transmitting the speech-converted calling party identification information to the headset.

12. A telecommunications method in accordance with claim 9, said headset comprising a Bluetooth-compatible headset.

13. A telecommunications method in accordance with claim 9, further including accessing an address book for a name corresponding to a number received as said text-based calling party identification information.

14. A telecommunications method in accordance with claim 13, said accessing an address book for a name corresponding to a number received as said text-based calling party identification information including said headset accessing the telephone for the address book.

15. A telecommunications method in accordance with claim 13, said accessing an address book for a name corresponding to a number received as said text-based calling party identification information including said telephone accessing a telephone address book.

16. A telecommunications system including a cellular telephone and a Bluetooth compatible headset, said cellular telephone including a calling party identification unit configured to determine a calling party number, wherein the cellular telephone is configured to provide calling party identification information to the Bluetooth-compatible headset for audio delivery.

17. A telecommunications system in accordance with claim 16, wherein the cellular telephone is configured to convert text-based calling party identification information to speech prior to delivery to the headset.

18. A telecommunications system in accordance with claim 16, wherein the cellular telephone is configured to provide text-based calling party identification information to the headset and the headset is configured to convert the text to speech prior to delivery to the headset.

19. A telecommunications system in accordance with claim 16, further including an address book, wherein the headset is configured to access the address book for a name corresponding to a number received as calling party identification information.

20. A telecommunications system in accordance with claim 16, further including an address book, wherein the cellular telephone is configured to access the address book for a name corresponding to a number received as calling party identification information.
